(19) United States
(12) Patent Application Publication
(10) Pub. No.: US 2009/0007524 A1
(43) Pub. Date: Jan. 8, 2009

(54) Device for Producing Deep Packaging Trays Comprising a Cooled Lower Mould Section

(76) Inventors: Jorg Feisel, Biedenkopf (DE); Klaus Meyer, Breidenbach (DE)

Correspondence Address: DOBRUSIN & THENNISCH PC, 29 W LAWRENCE ST, SUITE 210, PONTIAC, MI, 48342, US

(21) Appl. No.: 11/817,202

(22) PCT Filed: Mar. 1, 2006
(86) PCT No.: PCT/EP2006/001868

§ 371 Date: May 23, 2008

(30) Foreign Application Priority Data
Mar. 1, 2005 (DE) 10 2005 009 868.1
Mar. 1, 2005 (DE) 10 2005 009 870.3
Apr. 18, 2005 (DE) 10 2005 017 937.1

(51) Int. Cl. B65B 47/02; B65B 9/04; B29C 51/42

(52) U.S. Cl. 53/453; 53/141; 425/384

(57) ABSTRACT

The invention relates to a device and method for producing deep-drawn packaging trays and a packaging machine provided with the inventive device.

The present invention relates to a device and a method for producing thermoformed packaging trays and to a packaging machine that has the device according to the invention.

Nowadays, food is increasingly frequently offered in plastic packages, with a packaging tray in which the items of food are placed, and a cover film, with which the packaging tray is closed. The packaging trays are generally produced by thermoforming from a planar film web, the thermoforming being performed according to the prior art with a heated thermoforming mold. However, packaging trays that are produced with such a mold have the disadvantage that the thermoformed film shrinks during or after the thermoforming and this has the result in particular that the edges of the packages are not straight.

It was therefore the object of the present invention to provide a device with which the shrink effect is at least reduced.

The object is achieved by a device for producing thermoformed packaging trays from a shrinkable film web with a thermoforming mold, the thermoforming mold being cooled during the thermoforming.

It was extremely surprising and unexpected for a person skilled in the art that such a device allows packaging trays with straight package edges to be produced from a shrinkable plastic film and/or that the unwanted reverse shrinkage of the produced packaging tray immediately after the thermoforming is at least reduced. This allows packaging containers with an entirely new appearance and a very reproducible size to be produced.

For the purposes of the invention, a shrinkable film is a thermoformable multilayer film with a heat shrinkability in the longitudinal and transverse directions of respectively at least 20%, the heat shrinkability not being substantially influenced by thermoforming. With preference, the heat shrinkability of the multilayer films according to the invention in the longitudinal and transverse directions is respectively at least 25%, with more preference at least 30%, with still more preference at least 35%, with greatest preference at least 40% and in particular at least 45%. Such films are disclosed for example in DE 10 2005 017 937.1, which is hereby introduced as a reference and is consequently considered to be part of the disclosure.

According to the invention, the thermoforming mold is cooled during the thermoforming. The thermoforming mold preferably has cooling means for this. Such cooling means may be, for example, cooling lines which are arranged in the region of the thermoforming mold and through which a cooling medium, for example a cooling liquid or a cooling gas, circulates.

The device preferably has holding means, so that the film can be clamped between the holding means and the thermoforming mold. The holding means is preferably a clamping frame. The holding means is preferably arranged such that it is vertically displaceable. The film web is preferably fixed by the holding means before the thermoforming is performed. In a preferred embodiment of the present invention, this holding means is likewise provided with a cooling means, which may be connected to the same coolant circuit as the thermoforming mold or to another cooling circuit.

Suitable in particular as coolant is a coolant that is also used for example in refrigerators and the like. This preferred embodiment of the present invention has the advantage that the region of the packaging tray to which a cover film is sealed in a further method step does not have any stresses, or only very low stresses, which results in fewer leaks in the region of the sealed seam.

At least, one coolant circuit is preferably regulated, for example temperature-regulated, so that the thermoforming mold and/or the holding means is/are always at a virtually constant temperature.

Furthermore, with preference, the device according to the invention has a heating means, with particular preference a heating plate, with which the film web can be heated up, in particular before the thermoforming. With the heating means, the film web is heated at least in certain regions up to the plastifying temperature. The heating is preferably performed very quickly. With particular preference, the device according to the invention has means with which the contact, and consequently heat transfer, between the film web and the heating means is improved. With particular preference, this contact is improved by negative and/or positive pressure, which sucks and/or presses the film web onto the heating means. For the case in which a number of packaging trays are produced simultaneously, the device according to the invention preferably has a heating means for each packaging tray to be produced. The heating means are preferably vertically displaceable, can be switched on and off and/or can be regulated in their temperature. Once the film web has been heated, and with particular preference before the thermoforming, the heating means is again removed from the film web and/or switched off, in order to avoid overheating of the film web and in order to avoid too much heat having to be removed in the cooling of the thermoforming mold or of the heating means. The heating is preferably performed in a locally very targeted manner and very quickly, so that only the desired regions are heated. After or during the thermoforming, the film web is then cooled down as quickly as possible, in order to avoid unwanted recovery of the thermoformed packaging trays. A person skilled in the art realizes that the heating and cooling can also be performed simultaneously, in order to avoid certain regions of the film web being heated along with it when it is being heated and/or to reduce undesired heating up of these regions and/or to avoid unwanted recovery.

In a further preferred embodiment of the present invention, the device according to the invention has vacuum and/or pressure means, by which the film web is pressed or drawn into the thermoforming mold and is thereby given its final shape or to improve the heat transfer between the film web and the thermoforming mold. The same or other vacuum and/or pressure means may also be used for improving the contact between the undeformed film web and the heating means.

The device according to the invention is suitable in particular for producing shrinkable packaging trays for packages. The present invention therefore also relates to a packaging machine, preferably what is known as a form-fill-seal packaging machine or a tray former.

The present invention also relates to a method for producing thermoformed packaging trays from a film web in which the film web is first partially heated up and is partially cooled before and during the thermoforming.

It was extremely surprising and unexpected for a person skilled in the art that such a method allows packaging trays with straight package edges to be produced and/or that no unwanted shrinkage takes place after the thermoforming. This allows packaging containers with an entirely new appearance and a very reproducible size to be produced.

The film web is preferably clamped before the thermoforming. The clamping of the film web is preferably performed with a clamping frame. With particular preference, this clamping frame is cooled and, with most preference, is arranged such that it is vertically displaceable. A cooled clamping frame has the advantage that the later sealing region is at least virtually free from stress, which leads to fewer leaks in the sealing region.

Furthermore, with preference, the film web is heated up before the thermoforming. The heating up and cooling are preferably performed at different times, the heating up preferably being performed before the cooling. Furthermore, with preference, one surface of the film web is heated up and the opposite surface is cooled. In a further preferred embodiment of the present invention, the heating and cooling are performed simultaneously, the film web being heated up and cooled down in certain regions. With particular preference, the film web is pressed or sucked in the direction of the heating or cooling means, in order to achieve a heat transfer that is as good as possible. In the event that a number of packaging trays are produced simultaneously, each packaging tray to be produced is preferably assigned a heating means. This allows the required heat to be introduced into the film web in a locally very targeted manner.

The thermoforming may be performed in any way with which a person skilled in the art is familiar. However, the thermoforming is preferably performed by positive and/or negative pressure (vacuum). Furthermore, with preference, the thermoforming is performed with a die or the thermoforming is assisted by a die, it being possible for the die and the heating means to be one component.

According to the invention, the film web is cooled, at least in certain regions, before, during and/or after the thermoforming. In particular the region that has been thermoformed is cooled during and/or after the thermoforming until there is no longer any unwanted recovery of the thermoformed region. This is generally at temperatures below the plastifying temperature of the respective film.

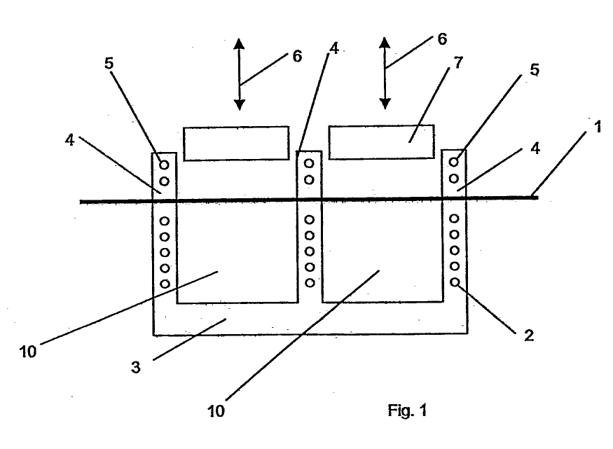

The invention is explained below on the basis of FIGS. 1 to 5. These explanations are given merely by way of example and do not restrict the general concept of the invention. The explanations apply equally to the device according to the invention, the package according to the invention and the method according to the invention.

FIG. 1 shows the device according to the invention before the thermoforming.

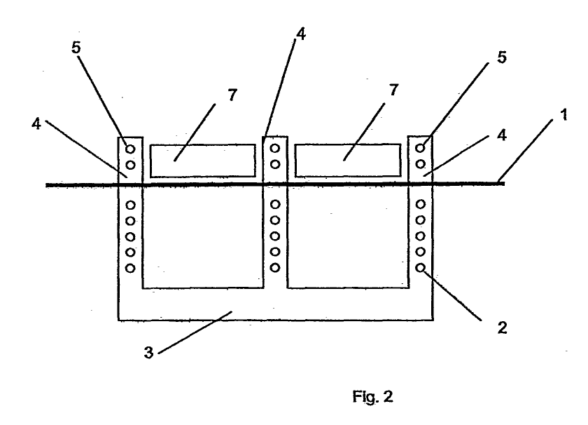

FIG. 2 shows the heating of the film web.

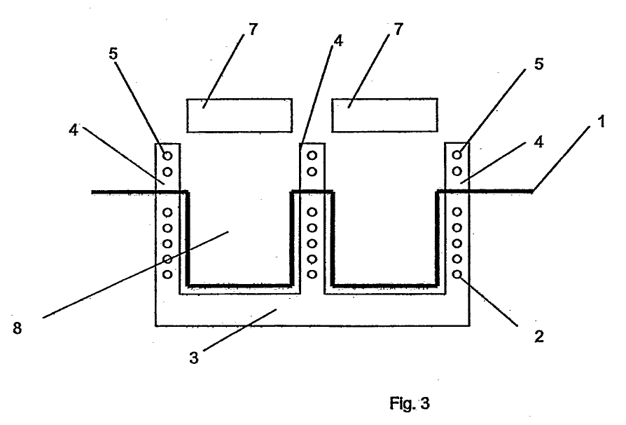

FIG. 3 shows the thermoforming of the packaging tray.

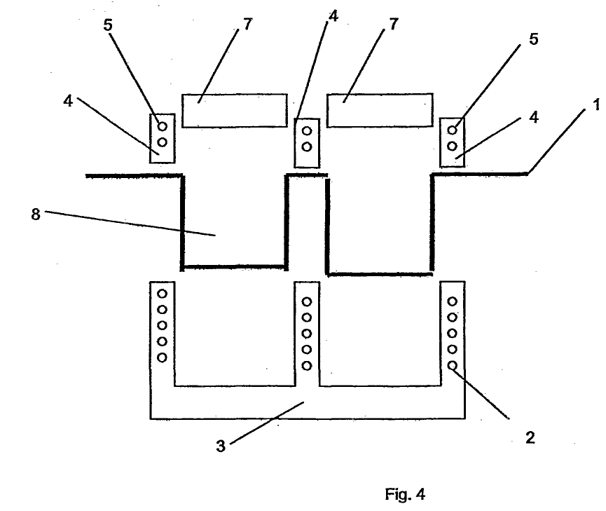

FIG. 4 shows the releasing of the holding means.

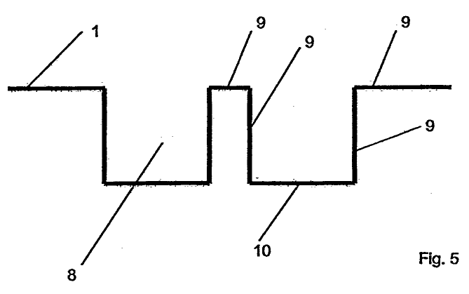

FIG. 5 shows the resulting packaging tray.

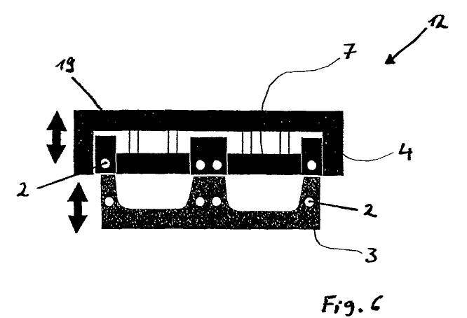

FIG. 6 shows the device according to the invention.

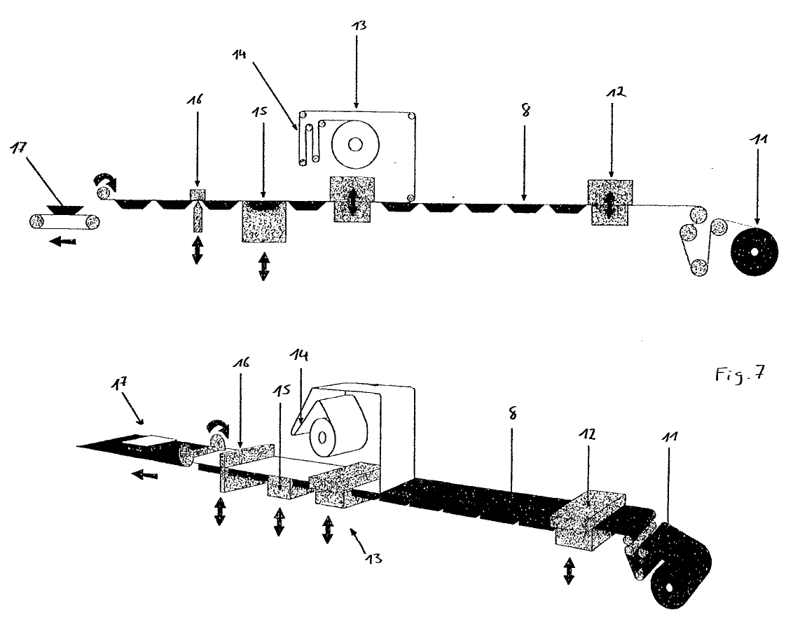

FIG. 7 shows a packaging machine for producing a shrink plate.

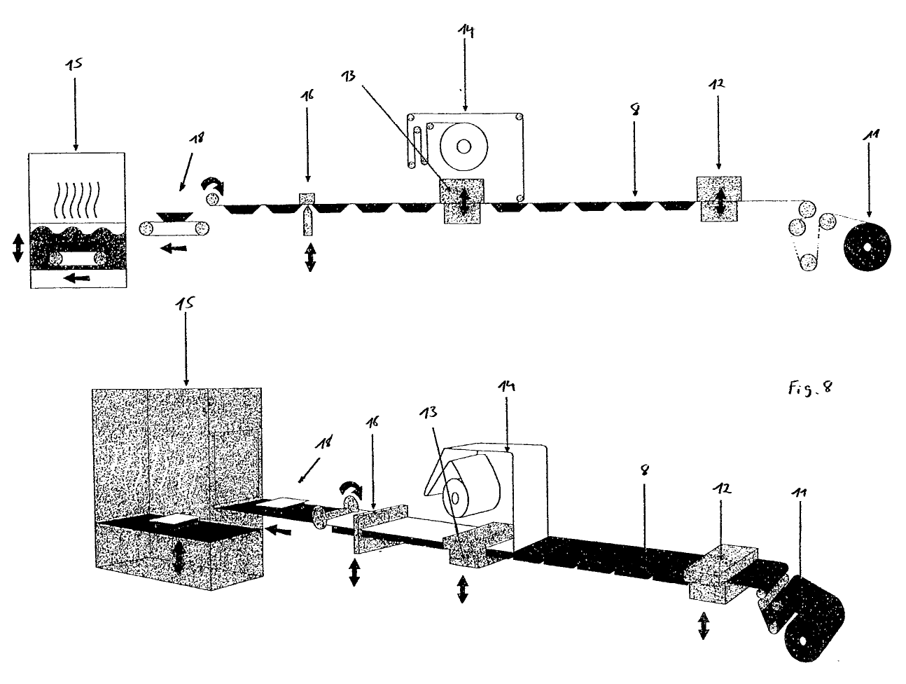

FIG. 8 shows a packaging machine for producing a shrink pack.

Represented in FIG. 1 is the device according to the invention, which has a thermoforming mold 3 with a number of thermoforming chambers 10. According to the invention, this thermoforming mold is cooled, the cooling being performed in the present case by bore 2, through which a cooling medium is passed. Above the thermoforming mold 3 is the film web 1 to be deformed, which is clamped between the thermoforming mold 3 and a clamping frame 4. The clamping frame 4 can likewise be cooled in the present case, by means of the bore 5, through which a coolant is passed. Above the film web 1 are heating plates 7, which can be raised and lowered, as indicated by the double-headed arrows 6. A person skilled in the art knows that the thermoforming mold 3 is likewise vertically movable.

FIG. 2 shows the heating of the film web 1 clamped between the clamping frame 4 and the thermoforming mold 3. For this, the heating plates 7 are lowered, so that they are preferably in contact with the film web. The film web is heated up until it is at the desired temperature in the region of the heating plate. The heating is preferably performed in a time-controlled manner.

As soon as the film has been sufficiently heated, the heating plates are raised again and the thermoforming of the film web 1 for producing the vacuum trays 8 is performed (FIG. 3). In the present case, the thermoforming chambers 10 can be subjected to a vacuum, by which the film web is deformed in the way represented. During the entire heating-up and thermoforming process, the thermoforming mold and the clamping frame are cooled.

As soon as the packaging trays 8 are thermoformed (FIG. 4), the thermoforming mold 3 is lowered, so that the packaging trays 8 come out of the thermoforming mold 3. The thermoforming mold is lowered to the extent that the produced packaging trays can be transported out from the thermoforming region and renewed deforming of the film web 1 can be performed.

Represented in FIG. 5 are the finished packaging trays. The cooling of the thermoforming mold has the effect that the pack edges 9 and/or the bottom of the package are straight, because the film web does not shrink at all after the thermoforming, or shrinks only very little after or during the thermoforming.

FIG. 6 shows the device according to the invention for producing thermoformed plastic packaging trays from shrinkable films of a shrinkable film web. The device 12 has a lower mold 3 and an upper mold 19. The lower mold 3 comprises the negative of the shape of the packaging tray to be produced. Incorporated in the lower mold are channels 2, through which a coolant by which the lower mold is cooled is circulated. As indicated by the double-headed arrow, the lower mold can be lowered and raised. The film web (not presented) runs between the lower mold and the upper mold. The upper mold 19 can likewise be raised and lowered. The same applies to the clamping frame 4 and the heating means 7. With the clamping frame, the film web is pressed against the lower mold and firmly clamped, in order that it can be thermoformed. The clamping frame 4 also additionally has channels 2, through which a coolant is circulated, so that the frame of the clamping frame 4 can be cooled. The cooling of the clamping frame has the advantage in particular that the film web that is located under the clamping frame is not heated and is consequently free from stress. The upper film is later sealed onto this region. The fact that this region is free from stress has the effect that the sealing of the later resulting package has a very high level of impermeability. The device according to the invention has a separately controllable heating 7 for each packaging tray to be produced, possibly comprising a number of heating elements, for example heating cartridges. With this (these) heating element(s), the film web is heated as quickly as possible. In order to improve the heat transfer between the film web and the respective heating means, a positive pressure may be produced in the region under the film web, pressing the film web against the heating means and thereby improving the heat transfer. A person skilled in the art recognizes that a negative pressure may also be produced between the film web and the heating means 7, sucking the film web against the heating means. As soon as the film web has reached its plastifying temperature, it is pressed into the respective thermoforming mold by the heating means 7, which then acts at the same time as a die, and/or a negative pressure is established in the thermoforming mold, sucking the film web into the thermoforming mold. This thermoforming mold is cooled, so that the film web is cooled during and/or immediately after the thermoforming. This cooling is performed until the film web has reached a temperature at which unwanted recovery of the packaging tray on account of the shrinkability of the film can be ruled out.

FIG. 7 shows a packaging machine for producing a shrink plate, i.e. a package with a shrinkable packaging tray, which is closed by a non-shrinkable, comparatively rigid cover film. A film web is unrolled intermittently from a roll 11 and packaging trays 8 are molded into the film web in the thermoforming device 12. These packaging trays 8 are then filled with an item to be packed (not represented) and after that closed with a cover film 14 in the sealing station 13. In the present case, the film web 11 comprises a shrinkable film while the film web 14 is non-shrinkable and relatively rigid, so that it acts like a tray. After the sealing, the packaging tray is shrunk in a shrinking device 15, only the thermoformed packaging tray coming into contact with a hot medium, for example hot air, steam or water. The shrunk packages completed in this way are then individually separated by the cutting device 16 and transported away as finished package 17. The respective double-headed arrows show that one or two units of the respective station can be raised and lowered.

FIG. 8 shows a packaging machine for producing a shrink pack in two views. A shrink pack comprises a shrinkable upper film and a shrinkable lower film. Once again, the shinkable film web is unrolled from a roll 11 and the packaging trays 8 are molded into the film web by thermoforming in a forming station 12. Once the packaging trays have been filled with an item to be packed (not represented), the packaging tray is closed by sealing with a film web 14 in the sealing station 13. In the present case, the cover film is likewise a shrinkable film. In a next method step, the packaging is individually separated in a cutting station 16. The packages 18 produced in this way are shrunk in a shrinking tunnel, in which they are subjected to boiling water, hot air or steam from all sides. The respective double-headed arrows show that one or two units of the respective station can be raised and lowered.

### LIST OF DESIGNATIONS

1 film web
2 cooling means
3 thermoforming mold, lower mold
4 holding means, clamping frame
5 cooling means
6 bottom of the packaging tray, double-headed arrow
7 heating means, heating plates, heating element, heating cartridge
8 packaging tray
9 pack edges
10 pack bottom
11 roll of film
12 thermoforming station
13 sealing station
14 upper film
15 shrinking station, shrinking tunnel
16 cutting station
17 finished, shrunk package
18 package before shrinking
19 upper mold

1. A device for producing thermoformed plastic packaging trays from a shrinkable film web with a thermoforming mold, the thermoforming mold being cooled during the thermoforming and it being possible for the film web to be clamped between a holding means and the thermoforming mold, characterized in that the holding means can be cooled by cooling means.

2. The device as claimed in claim 1, characterized in that it has cooling means.

3. The device as claimed in claim 1, characterized in that it has a heating means, including a heating plate, with which the film web can be heated up.

4. The device as claimed in claim 3, characterized in that the heating plate is configured as a thermoforming die.

5. The device as claimed in claim 1, characterized in that it has vacuum and/or pressure means for thermoforming the film.

6. A packaging machine having a device as claimed in claim 1.

7. A method for producing a thermoformed packaging tray from a film web, the film web being partially cooled during the thermoforming, characterized in that the partial region of the film web from which the tray is molded is heated up and the sealing region the packaging tray is cooled, at least during the heating up.

8. The method as claimed in claim 7, characterized in that the film web is clamped before the thermoforming.

9. The method as claimed in claim 1, characterized in that the film web is deformed by positive and/or negative pressure.

10. The device as claimed in claim 2, characterized in that it has a heating means, including a heating plate, with which the film web can be heated up.

11. The device as claimed in claim 10, characterized in that the heating plate is configured as a thermoforming die.

12. The device as claimed in claim 2, characterized in that it has vacuum and/or pressure means for thermoforming the film.

13. The device as claimed in claim 3, characterized in that it has vacuum and/or pressure means for thermoforming the film.

14. The device as claimed in claim 10, characterized in that it has vacuum and/or pressure means for thermoforming the film.

15. The device as claimed in claim 4, characterized in that it has vacuum and/or pressure means for thermoforming the film.

16. The device as claimed in claim 11, characterized in that it has vacuum and/or pressure means for thermoforming the film.

17. A packaging machine having a device as claimed in claim 1.

18. A packaging machine having a device as claimed in claim 3.

19. A packaging machine having a device as claimed in claim 16.

20. The method as claimed in claim 8, characterized in that the film web is deformed by positive and/or negative pressure.
